(19) United States
(12) Patent Application Publication
(10) Pub. No.: US 2013/0185535 A1
(43) Pub. Date: Jul. 18, 2013

(54) APPARATUS AND METHOD FOR PROCESSING NON-SEQUENTIALLY STORED DATA

(71) Applicant: Electronics and Telecommunication Research Institute, Daejeon (KR)

(72) Inventors: Hyun Gu PARK, Daejeon (KR); Sok Kyu LEE, Daejeon (KR)

(73) Assignee: Electronics and Telecommunication Research Institute, Daejeon (KR)

(21) Appl. No.: 13/742,950

(22) Filed: Jan. 16, 2013

(30) Foreign Application Priority Data
Jan. 16, 2012 (KR) 10-2012-0004809

(51) Int. Cl. G06F 12/00

(52) U.S. Cl. CPC G06F 12/00
USPC 711/202

(57) ABSTRACT

An apparatus and method for processing non-sequentially stored data is provided. The data processing apparatus may include an order information mapping unit to map transmission order information to data, an address list generating unit to generate an address list including addresses of the data arranged sequentially based on the transmission order information, and a data processing unit to process the data corresponding to each of the addresses based on an address order of the address list.

### CROSS-REFERENCE TO RELATED APPLICATION

This application claims the priority benefit of Korean Patent Application No. 10-2012-0004809, filed on Jan. 16, 2012, in the Korean Intellectual Property Office, the disclosure of which is incorporated herein by reference.

### BACKGROUND

1. Field of the Invention

Exemplary embodiments relate to an apparatus and method for processing non-sequentially stored data, and more particularly, to an apparatus and method for processing non-sequentially stored data in a transmission order of the data, absent sorting memory addresses of the data in the transmission order.

2. Description of the Related Art

When data is transmitted and received between a device and a host using a secure digital input/output (SDIO) interface, the data may be stored in an address of a memory sequentially as received and may be processed in an address order of the memory.

However, when a storage address of data in a memory is empty after the data is processed, or when various interrupts occur or a request by a user is present, data stored in a certain address of a memory may be processed earlier than a given order in which the data is to be processed. Accordingly, an inconsistency between an address order of a memory in which data is stored and a processing order in which the data is to be processed may be present.

Conventionally, to match an address order of a memory with a processing order of data, sorting of memory addresses is required.

However, this sorting procedure may cause a time delay since an amount of time taken in reading and writing data is O(n log n) when a number of the data is ‘n’.

Accordingly, there is a need for a method of processing non-sequentially stored data in a transmission order of the data, absent sorting memory addresses of the data in the transmission order.

### SUMMARY

An aspect of the present invention provides an apparatus and method for processing non-sequentially stored data in a transmission order of the data, absent sorting memory addresses of the data in the transmission order.

According to an aspect of the present invention, there is provided a data processing apparatus including an order information mapping unit to map transmission order information to data, an address list generating unit to generate an address list including addresses of the data arranged sequentially based on the transmission order information, and a data processing unit to process the data corresponding to each of the addresses based on an address order of the address list.

According to another aspect of the present invention, there is provided a data processing method including mapping transmission order information to data, generating an address list including addresses of the data arranged sequentially based on the transmission order information, and processing the data corresponding to each of the addresses based on an address order of the address list.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a relationship between a data processing device and another device according to an embodiment of the present invention;

FIG. 2 is a block diagram illustrating a data processing device according to an embodiment of the present invention;

FIG. 3 is a diagram illustrating an example of mapping transmission order information to data by an order information mapping unit;

FIG. 4 is a according to an example of generating an address list by an address list generating unit; and

FIG. 5 is a flowchart illustrating a data processing method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

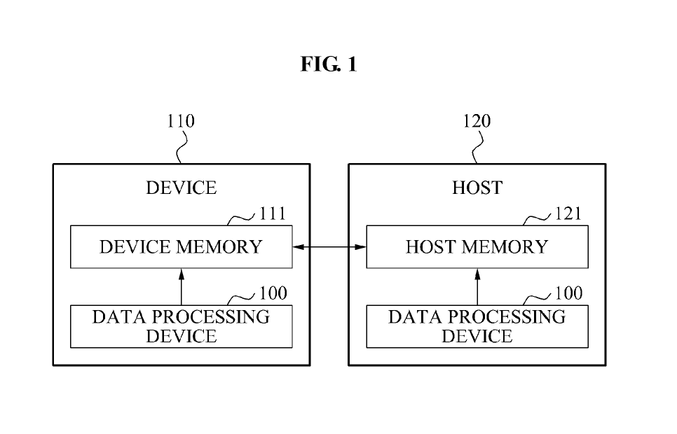

FIG. 1 is a diagram illustrating a relationship between a data processing device 100 and another device according to an embodiment of the present invention.

Referring to FIG. 1, data transmitted from a host 120 to a device 110 over a secure digital input and output (SDIO) interface may be stored in a device memory 111 of the device 110, and data transmitted from the device 110 to the host 120 over the SDIO interface may be stored in a host memory 121 of the host 120. In this instance, the data may be stored in addresses of the memory sequentially as received, and may be processed in an address order of the memory. To process the data in an order in which the data is transmitted, a need to sort the memory addresses in a transmission order is present.

When a request by a user is present for processing of the data stored in the device memory 111 of the device 110 or the host memory 121 of the host 120 in a transmission order of the data, the data processing device 100 may generate, in response to the request, an address list including the transmission order of the data and addresses of the data and may process the data using the generated address list.

By generating the address list including the transmission order, the data processing device 100 may process the data in the transmission order absent sorting the memory addresses in the transmission order.

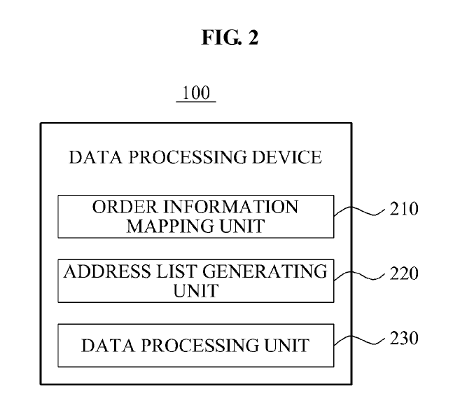

FIG. 2 is a block diagram illustrating the data processing device 100 according to an embodiment of the present invention.

Referring to FIG. 2, the data processing device 100 may include an order information mapping unit 210, an address list generating unit 220, and a data processing unit 230.

The order information mapping unit 210 may map transmission order information to data stored in the device memory 111 or the host memory 121.

The order information mapping unit 210 may compare an order in which the data is stored in the memory 111 or 121 over the interface to an order in which addresses of the data in the memory are arranged, and when the storage order of the data in the memory is inconsistent with the address order of the memory, may map the transmission order information to the data. The order information mapping unit 210 may map the transmission order information to the data based on the storage order of the data in the memory.

The address list generating unit 220 may generate an address list including the addresses of the data arranged sequentially based on the transmission order information mapped to the data by the order information mapping unit 210. The address list generating unit 220 may identify a transmission order using the transmission order information mapped to the data, and may determine a location of the address of the data to be stored in the address list based on the identified transmission order.

The address list generating unit 220 may generate the address list by performing memory allocation based on a number of the data stored in the device memory 111 or the host memory 121. In this instance, a 0^{th} address in the address list may be referred to as ‘MEM’.

The address list generating unit 220 may identify the transmission order information mapped to the data stored sequentially from the 0^{th} address to a last address of the device memory 111 or the host memory 121. In this instance, a series of the transmission order information mapped to the data may be referred to as ‘ORDER’, and last transmission order information may be referred to as ‘LASTORDER’.

The address list generating unit 220 may generate the address list in which an ‘MEM+INDEX’ address has a memory address value identifying the ‘ORDER’. Here, ‘INDEX’ may correspond to a value obtained by subtracting ‘LASTORDER’ from ‘ORDER’.

The data processing unit 230 may process the data corresponding to each of the addresses based on an address order of the address list.

The data processing unit 230 may process the data based on the transmission order information, by identifying memory address values stored in INDEX 0 through N of the address list sequentially and processing the data corresponding to each of the identified memory address values. The data processing unit 230 may store last transmission order information in ‘LASTORDER’.

The address list generating unit 220 and the data processing unit 230 may use pseudocode of Table 1.

```
TABLE
For i = 0 to N
    index = lastorder − order[i]
    MEM[index] = i
End Loop
For i = 0 to N
    Process( DATA[MEM[i]] )
End Loop
lastorder = order[ MEM[N] ]
```

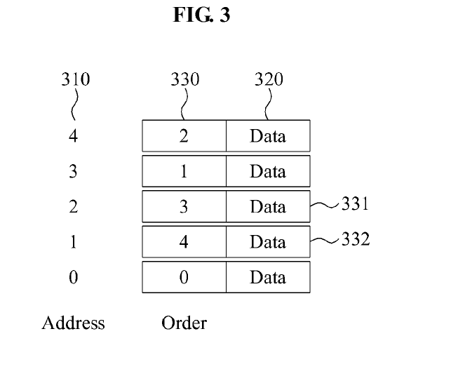

FIG. 3 is a diagram illustrating an example of mapping transmission order information to data in the order information mapping unit 210.

Referring to FIG. 3, transmission order information ‘ORDER’ 330 may be mapped to data 320 stored in a memory address ‘ADDRESS’ 310 by the order information mapping unit 210. In this instance, the transmission order information ‘ORDER’ 330 may correspond to transmission order information set by a user, or a storage order of the data 320 in the device memory 111 or the host memory 121.

In a case in which certain data is processed among data stored in the device memory 111 or the host memory 121 in response to a request by a user, a storage order of data in the device memory 111 or the host memory 121 may be inconsistent with an arrangement order of memory address values. According to the present invention, by mapping transmission order information to the data 320 based on the storage order of the data 320 by the order information mapping unit 210, the data 320 may be processed in the storage order of the data 320 in the device memory 111 or the host memory 121.

For example, when data stored in a 2^{nd} address among data stored sequentially from a 0^{th} address to a 4^{th} address is processed in response to a request by a user, data 331 may be stored in the empty 2^{nd} address. Since the data 331 is stored later than data stored in a 0^{th} address, a 1^{st} address, a 3^{rd} address, and a 4^{th} address, the order information mapping unit 210 may map, to the data 331, later transmission order information than the data stored in the 0^{th} address, the 1^{st} address, the 3^{rd} address, and the 4^{th} address. Accordingly, last transmission order information may be mapped to the data 331 stored in the 2^{nd} address, and the transmission order information mapped to the data stored in the 0^{th} address, the 1^{st} address, the 3^{rd} address, and the 4^{th} address may correspond to 0, 1, 4, 2, and 3, respectively.

Subsequently, when the data stored in the 1^{st} address is processed in response to a request by the user or by an interrupt, data 332 may be stored in the empty 1^{st} address. Since the data 332 is stored later than the data stored in the 0^{th} address, the 3^{rd} address, and the 4^{th} address, as well as the data 331 stored in the 2^{nd} address, the order information mapping unit 210 may map, to the data 332, later transmission order information than data stored in the 0^{th} address, the 2^{nd} address, the 3^{rd} address, and the 4^{th} address. In this instance, since the 0^{th} address, the 3^{rd} address, and the 4^{th} address are unchanged, sequential transmission order information may be mapped to the data stored in the 0^{th} address, the 3^{rd} address, and the 4^{th} address, and last transmission order information may be mapped to the data 332 stored in the 1^{st} address. Accordingly, transmission order information mapped to the data stored in the 0^{th} address through the 4^{th} address may correspond to 0, 4, 3, 1, and 2, respectively, as shown in FIG. 3.

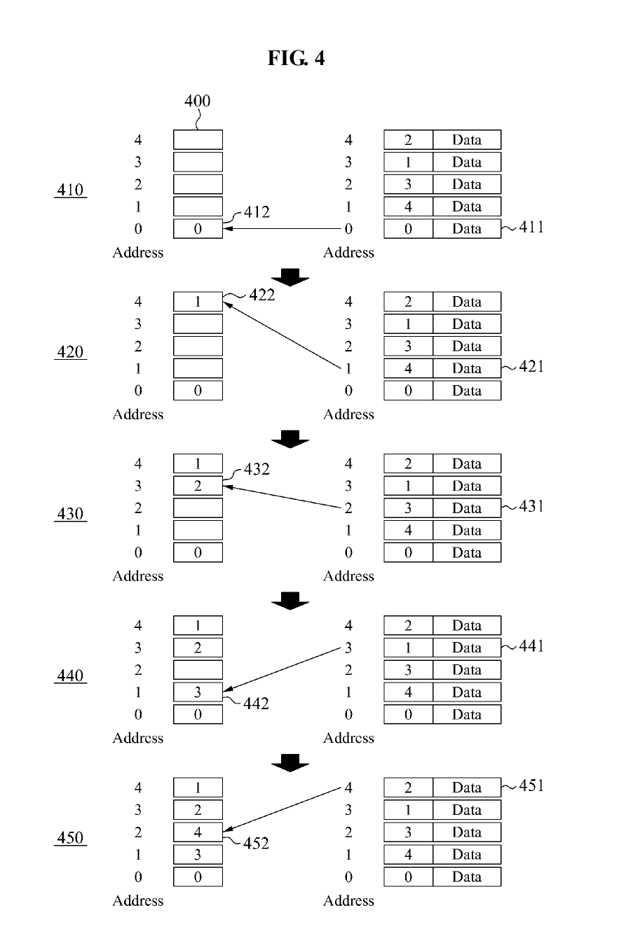

FIG. 4 is a according to an example of generating an address list by the address list generating unit 220.

In 410, the address list generating unit 220 may identify transmission order information mapped to data of a 0^{th} address 411 of the device memory 111 or the host memory 121. Since the identified transmission order information is 0, the address list generating unit 220 may store a value of the 0^{th} address 411 of the device memory 111 or the host memory 121 in a 0^{th} address 412 of the address list.

In 420, the address list generating unit 220 may identify transmission order information mapped to data of a 1^{st} address 421 of the device memory 111 or the host memory 121. Since the identified transmission order information is 4, the address list generating unit 220 may store a value of the 1^{st} address 421 of the device memory 111 or the host memory 121 in a 4^{th} address 422 of the address list.

In 430, the address list generating unit 220 may identify transmission order information mapped to data of a 2^{nd} address 431 of the device memory 111 or the host memory 121. Since the identified transmission order information is 3, the address list generating unit 220 may store a value of the 2^{nd} address 431 of the device memory 111 or the host memory 121 in a 3^{rd} address 432 of the address list.

In 440, the address list generating unit 220 may identify transmission order information mapped to data of a 3^{rd} address 441 of the device memory 111 or the host memory 121. Since the identified transmission order information is 1, the address list generating unit 220 may store a value of the 3^{rd} address 441 of the device memory 111 or the host memory 121 in a 1^{st} address 442 of the address list.

In 450, the address list generating unit 220 may identify transmission order information mapped to data of a 4^{th} address 451 of the device memory 111 or the host memory 121. Since the identified transmission order information is 2, the address list generating unit 220 may store a value of the 4^{th} address 451 of the device memory 111 or the host memory 121 in a 2^{nd} address 452 of the address list.

The resulting address list may include addresses in an order of the 0^{th} address 411, the 3^{rd} address 441, the 4^{th} address 451, the 2^{nd} address 431, and the 1^{st} address 421. Accordingly, the data processing unit 230 may process data in an order of the data of the 0^{th} address 411, the data of the 3^{rd} address 441, the data of the 4^{th} address 451, the data of the 2^{nd} address 431, and the data of the 1^{st} address 421.

Accordingly, the data transmitting unit 230 may process data in a storage order of the data in a memory or a desired order by a user, absent sorting addresses of the memory in which the data is stored.

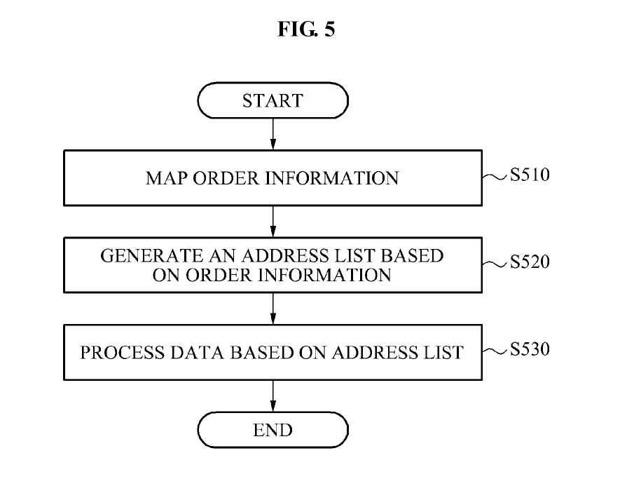

FIG. 5 is a flowchart illustrating a method of transmitting data according to an embodiment of the present invention.

In S510, the order information mapping unit 210 may map transmission order information to data stored in the device memory 111 or the host memory 121.

In S520, the address list generating unit 220 may generate an address list including addresses of the data arranged sequentially based on the transmission order information mapped in S510.

In S530, the data processing unit 230 may process the data corresponding to each of the addresses in an address order of the address list generated in S520.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to the exemplary embodiments of the present invention, non-sequentially stored data may be processed in a transmission order of the data absent sorting memory addresses in a transmission order, by identifying the transmission order of the data and generating an address list including the transmission order.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A data processing apparatus comprising:
an order information mapping unit to map transmission order information to data;
an address list generating unit to generate an address list including addresses of the data arranged sequentially based on the transmission order information; and
a data processing unit to process the data corresponding to each of the addresses based on an address order of the address list.

2. The apparatus of claim 1, wherein the address list generating unit identifies a transmission order of the data using the transmission order information mapped to the data, and determines a location of each address of the data to be stored in the address list based on the identified transmission order.

3. The apparatus of claim 1, wherein the order information mapping unit compares the order in which the addresses of the data are arranged in the address list to an order in which the data is stored in a memory over a secure digital input/output (SDIO) interface, and when the address order of the address list is inconsistent with the storage order of the data in the memory, maps the transmission order information to the data.

4. The apparatus of claim 3, wherein the order information mapping unit identifies the transmission order of the data based on the storage order of the data in the memory, and maps the transmission order information to the data based on the identified transmission order.

5. A data processing method comprising:
mapping transmission order information to data;
generating an address list including addresses of the data arranged sequentially based on the transmission order information; and
processing the data corresponding to each of the addresses based on an address order of the address list.

6. The method of claim 5, wherein the generating of the address list comprises:
identifying a transmission order of the data using the transmission order information mapped to the data; and
determining a location of each address of the data to be stored in the address list based on the identified transmission order.

7. The method of claim 5, wherein the mapping of the transmission order information comprises:
comparing the order in which the addresses of the data are arranged in the address list to an order in which the data is stored in a memory over a secure digital input/output (SDIO) interface; and
mapping the transmission order information to the data when the address order of the address list is inconsistent with the storage order of the data in the memory.

8. The method of claim 7, wherein the mapping of the transmission order information comprises:
identifying the transmission order of the data based on the storage order of the data in the memory; and
mapping the transmission order information to the data based on the identified transmission order.
